(19) United States
(12) Patent Application Publication
(10) Pub. No.: US 2017/0225978 A1
(43) Pub. Date: Aug. 10, 2017

(54) REMOVAL OF HYDRATE INHIBITORS FROM WASTE STREAMS

(71) Applicant: Ecolab USA Inc., St. Paul, MN (US)

(72) Inventors: Jeremy Wayne Bartels, Sugar Land, TX (US); Regan Andrew Jones, Sugar Land, TX (US); Rebecca Michele Lucente-Schultz, Missouri City, TX (US)

(21) Appl. No.: 15/423,797

(22) Filed: Feb. 3, 2017

Related U.S. Application Data
(60) Provisional application No. 62/291,448, filed on Feb. 4, 2016.

(51) Int. Cl. C02F 1/52; C08L 33/02

(52) U.S. Cl. CPC C02F 1/5272; C08L 33/02; C08L 2201/54

(57) ABSTRACT

The present invention generally relates to methods and high molecular weight polymeric flocculants for removing a polymeric low dose hydrate inhibitor. More specifically, the method comprises contacting a high molecular weight polymeric flocculant to an aqueous fluid containing the polymer low dose hydrate inhibitor. The high molecular weight polymeric flocculants comprises repeating units derived from an anionic monomer.

### CROSS-REFERENCE TO RELATED APPLICATION

This application claims priority to U.S. Provisional Patent Application Ser. No. 62/291,448 filed on Feb. 4, 2016, the disclosure of which is incorporated herein by reference in its entirety.

### FIELD OF THE INVENTION

The present invention generally relates to methods for the removal of low dose hydrate inhibitors from an aqueous fluid containing the polymeric low dose hydrate inhibitor. The method comprises contacting the aqueous fluid containing the polymeric low dose hydrate inhibitor with a high molecular weight polymeric flocculant.

### BACKGROUND OF THE INVENTION

Low-boiling hydrocarbons, such as methane, ethane, propane, butane, and iso-butane, are normally present in conduits which are used for the transport and processing of oil and gas. If a substantial amount of water also is present, it is possible that the water/hydrocarbon mixture forms gas hydrate crystals under conditions of low temperature and elevated pressure. These crystals can be formed in a fluid whether the fluid is flowing or stationary.

Gas hydrates, also known as clathrates, are crystalline solids composed of water and gas. In these solids, the gas molecules (guests) are trapped in water cavities (host) that are composed of hydrogen-bonded water molecules. Methane is the main gas in naturally occurring gas hydrates, however carbon dioxide, hydrogen sulfide, and less frequently, other hydrocarbons such as ethane and propane can be found within the hydrate structure.

Gas hydrates can be easily formed during the transportation of oil and gas in pipelines under certain conditions. Factors affecting gas hydrate formation include gas composition, water content, temperature, and pressure, particularly low temperature and high pressure. While these crystalline cage-like structures are small initially, they are able to agglomerate into solid masses called gas hydrate plugs. The formation of gas hydrates within a pipeline often results in lost oil or gas production, damage to transmission lines and equipment, and safety hazards to field workers.

Three types of hydrate inhibitors are currently available to the energy industry for controlling gas hydrates: thermodynamic hydrate inhibitors (THIs), kinetic hydrate inhibitors (KHIs), and anti-agglomerants (AAs). Thermodynamic hydrate inhibitors must be added in large amounts to be effective, typically on the order of several tens of percent by weight of the water present. On the other hand, KHIs and AAs are typically added on the order of one to five percent by weight of the water present.

Produced water that contains any quantity of LDHIs (particularly KHIs but also potentially AAs) can cause problems including fouling of injection/disposal wells and damage to reservoirs. Furthermore, by reinjecting produced water, these inhibitors can become insoluble and precipitate at high temperatures resulting in blocked underground reservoirs, wells, and the like. Additionally, this blockage can result in reduced injection efficiency and result in reduced hydrocarbon extraction and recovery.

Accordingly, there is an ongoing need for methods and compositions that can effectively remove water soluble hydrate inhibitors from waste water streams of various hydrocarbon extraction and recovery processes.

### SUMMARY OF THE INVENTION

One aspect of the invention is directed to a method for removing a polymer low dose hydrate inhibitor from an aqueous fluid containing the polymeric low dose hydrate inhibitor, the method comprising contacting the aqueous fluid containing the polymeric low dose hydrate inhibitor with a high molecular weight polymeric flocculant.

Other objects and features will be in part apparent and in part pointed out hereinafter.

### DESCRIPTION OF THE PREFERRED EMBODIMENTS

A method for removing low dose hydrate inhibitors, particularly polymeric kinetic hydrate inhibitors, from produced waste water streams prior to injection into a water disposal well is disclosed. The method comprises contacting a high molecular weight polymeric flocculant with the low dose hydrate inhibitors, particularly polymeric kinetic hydrate inhibitors. The contact of these two agents forms flocs that can be easily separated from the aqueous solution using well known separation techniques including filtration, settling, and the like. By removing the low dose hydrate inhibitors from the process waste water the issues with recycling the water into the hydrocarbon extraction and recovery process are reduced. Further, issues with kinetic hydrate inhibitors causing reservoir damage or degrading water quality are also addressed.

Precipitating kinetic hydrate inhibitors allows for disposal of the removed inhibitors and injection of the remaining inhibitor-free waste stream into various processes whether the presence of the kinetic hydrate inhibitors would be detrimental to the efficiency of the process.

The present invention is directed to a method for removing a polymeric low dose hydrate inhibitor from an aqueous fluid containing the polymeric low dose hydrate inhibitor, the method comprising contacting the aqueous fluid containing the polymeric low dose hydrate inhibitor with a high molecule weight polymeric flocculant.

The aqueous fluid can comprise a waste stream.

The waste stream can comprise an aqueous fluid, an organic fluid, or a combination thereof.

The high molecular weight polymeric flocculant can be added as a solid, in the form of a powder, or as a solution dissolved in an aqueous or organic fluid. The injection point of the flocculant is dependent on the positioning of piping and/or holding tanks for the particular system being treated. Upon contacting the flocculant to the system, the floc can form in a matter of seconds to minutes.

The floc can then be separated from the system depending on if it is batch or continuous system. For a batch system, a settling, e.g., a stationary, tank can be used but for a continuous system filtration/skimming can be used.

The high molecular weight polymeric flocculant can be added in a batch-wise or a metered injection method. The batch-wise injection method may be better suited for a stationary tank whereas a metered injection method may be better suited for a continuous flow process.

The high molecular weight polymeric flocculant can be formulated with other agents known in the art for this application.

The high molecular weight polymeric flocculant can comprise repeat units derived from an anionic monomer.

The anionic monomer can comprise acrylic acid, methacrylic acid, a vinyl sulfonate, a vinyl sulfonic acid, a styrene sulfonate, a styrene sulfonic acid, a vinyl alcohol, a vinyl phosphonate, a vinyl phosphoric acid, or a combination thereof.

The anionic monomer can comprise acrylic acid.

The high molecular weight polymeric flocculant can be synthesized by any means known in the art, such as, for example radical polymerization. Typically, the high molecular weight polymeric flocculant can be prepared by combining one or more vinyl monomers (e.g., monomers described herein) either in bulk or in an aqueous or alcohol solvent (e.g., water or alcohols) followed by stirring at room temperature or heating the reaction mixture from 30° C. to about 100° C. The reaction temperature can be from 1 to 30 minutes at 100° C. to 30 minutes to 10 hours at room temperature. During this time, an initiator (e.g., t-butyl peroctanoate) can be added to the reaction mixture. The polymer molecular weight can be controlled by altering the amount of initiator added to the reaction mixture.

The high molecular weight polyacrylic acid flocculant is commercially available from Sigma-Aldrich.

The molecular weight of the flocculants disclosed herein, are described in terms of viscosity average molecular weight. The viscosity average molecular weight (Mv) can be calculated from the viscosity of the polymer solution using the Mark-Houwink equation.

The molecular weight of the high molecular weight polymeric flocculant can be from about 100,000 Da to about 100,000,000 Da; from about 200,000 Da to about 100,000,000 Da; from about 300,000 Da to about 100,000,000 Da; from about 400,000 Da to about 100,000,000 Da; from about 500,000 Da to about 100,000,000 Da; from about 600,000 Da to about 100,000,000 Da; from about 700,000 Da to about 100,000,000 Da; from about 800,000 Da to about 100,000,000 Da; from about 900,000 Da to about 100,000,000 Da; preferably, from about 1,000,000 Da to about 100,000,000 Da.

The high molecular weight polymeric flocculant can be formulated with a polar solvent.

The polar solvent can comprise water, brine, methanol, ethanol, isopropyl alcohol, a C₁-C₁₀ alcohol, a C₁-C₁₀ diol, a C₁-C₁₀ carboxylic acid, a C₁-C₁₀ dicarboxylic acid, monoethylene glycol (MEG), diethylene glycol ethyl ether (EDGE), ethylene glycol monobutyl ether (EGMBE) or related glycol ethers, or a combination thereof.

The polar solvent can comprise water.

The high molecular weight polymeric flocculant can be formulated with a polar solvent at a concentration of from about 0.001 to about 10 wt. %, from about 0.01 to about 10 wt. %, from about 0.1 to about 10 wt. %, from about 0.5 to about 10 wt. %, from about 0.75 to about 10 wt. %, from about 1 to about 10 wt. %, from about 0.1 to about 8 wt. %, from about 0.1 to about 6 wt. %, from about 0.1 to about 4 wt. %, from about 0.1 to about 2 wt. %, from about 0.1 to about 1 wt. %, from about 0.5 to about 8 wt. %, from about 0.5 to about 6 wt. %, from about 0.5 to about 5 wt. %, from about 0.5 to about 4 wt. %, from about 0.5 to about 2 wt. %, or from about 0.5 to about 1 wt. %, based on the total weight of the composition.

The high molecular weight polymeric flocculant can be contacted with the aqueous fluid in the form of a solid or as a solution.

The high molecular weight polymeric flocculant can be contacted with the aqueous fluid as a solution.

The high molecular weight polymeric flocculant can be contacted with the aqueous fluid at a concentration from about 0.001 to about 10 wt. %, from about 0.01 to about 10 wt. %, from about 0.1 to about 10 wt. %, from about 0.5 to about 10 wt. %, from about 0.75 to about 10 wt. %, from about 1 to about 10 wt. %, from about 0.1 to about 8 wt. %, from about 0.1 to about 6 wt. %, from about 0.1 to about 4 wt. %, from about 0.1 to about 2 wt. %, from about 0.1 to about 1 wt. %, from about 0.5 to about 8 wt. %, from about 0.5 to about 6 wt. %, from about 0.5 to about 5 wt. %, from about 0.5 to about 4 wt. %, from about 0.5 to about 2 wt. %, or from about 0.5 to about 1 wt. %.

Preferably, the high molecular weight polymeric flocculant can be contacted with the aqueous fluid at a concentration from about 0.1 to about 2 wt. %.

The polymeric low dose hydrate inhibitor can comprise a polymeric kinetic hydrate inhibitor.

The polymeric low dose hydrate inhibitor can be a polyvinylcaprolactone; a polyvinylpyrrolidone; a copolymer of a polyvinylcaprolactone and a polyvinylpyrrolidone; a terpolymer of a polyvinylcaprolactone, a polyvinylpyrrolidone, and a polyvinyl acetate; a dendrimeric polyesteramide derived from hexahydrophthalic anhydride; diisopropanol amine, and N,N-bis(3-dimethylaminopropyl)amine; a substituted polyethyleneimine; a polyoxyalkylenediamine; a dicarboxylic acid-polyol polyester; a polycyclicpolyether polyol; a hyperbranched polyester polyol having hydroxyl end groups; a hyperbranched polyester polyamine; a hyperbranched polyamidoamine; a linear polyester polyamine; or a combination thereof.

Additionally, the polymeric low dose hydrate inhibitor can comprise repeat units derived from a first monomer, a second monomer, or a combination thereof.

For the polymeric low dose hydrate inhibitors, the first monomer can be an acrylamide monomer, acrylate monomer, N-vinyl monomer, N-vinyl caprolactam monomer, N-vinyl amine monomer, anhydride monomer, dicarboxylic acid monomer, diester monomer, diol monomer, amine monomer, diamine monomer, dihydroxy acid monomer, dihydroxy ester monomer, hydroxy ester monomer, hydroxy acid monomer, or a combination thereof. Preferably, the acrylamide monomer can comprise N-isopropyl methacrylamide, N-isopropylacrylamide, or a combination thereof.

For the polymeric low dose hydrate inhibitors, the second monomer can comprise methacrylamidopropyltrimethylammonium chloride, 2-(dimethylamino)ethyl methacrylamide, 3-(acryloylamino)propyl]trimethyl ammonium chloride (APTAC), 2-acryloyloxyethyltrimethyl ammonium chloride (AETAC), 2-methacryloyloxyethyltrimethyl ammonium chloride (METAC), diallyldimethyl ammonium chloride (DADMAC), acryloyloxyethyldimethylbenzyl ammonium chloride (AEDBAC), or methacryloyloxyethyldimethylbenzyl ammonium chloride (MEDBAC), 2-acrylamido-2-methylpropane sulfonic acid (AMPS), 2-acrylamido-2-methylpropane sulfonic acid sodium salt (AMPS sodium salt), or a combination thereof.

When the 2-(dimethylamino)ethyl methacrylamide is used as a second monomer, the resulting polymer, oligomer, or dendrimer comprising repeat units derived therefrom can be reacted (i.e., salted) with an organic acid (e.g., acetic acid, acrylic acid, and the like) or an inorganic acid (hydrochloric acid, sulfuric acid, and the like) to make an acid salt of the amine group.

The polymeric low dose hydrate inhibitors can comprise a copolymer or cooligomer comprising repeat units derived from N-isopropyl methacrylamide, methacrylamidopropyltrimethylammonium chloride, 2-(dimethylamino)ethyl methacrylamide, or a combination thereof. Preferably, the polymeric low dose hydrate inhibitors can comprise repeat units derived from isopropyl methacrylamide and methacrylamidopropyltrimethylammonium chloride.

The polymeric low dose hydrate inhibitor can be synthesized by any means known in the art, such as, for example radical polymerization. For example, representative polymers can be prepared by the free radical polymerization of a first monomer (e.g., an acrylamide monomer) and a second monomer (e.g., a methacrylamidopropyltrimethylammonium chloride or 2-(dimethylamino)ethyl methacrylamide monomer).

Typically, the polymeric low dose hydrate inhibitor can be prepared by combining one or more vinyl monomers (e.g., monomers described as the first monomer and second monomer herein) in an alcohol solvent (e.g., diethylene glycol monoethyl ether) followed by stirring and heating the reaction mixture to about 100° C. for two hours. During this time, an initiator (e.g., t-butyl peroctanoate) is added to the reaction mixture.

The high molecular weight polymeric flocculant can further be administered in conjunction with or formulated with a corrosion inhibitor, a solvent, an asphaltene inhibitor, a paraffin inhibitor, a scale inhibitor, an emulsifier, a water clarifier, a dispersant, a biocide, a pH modifier, a surfactant, or a combination thereof.

Suitable corrosion inhibitors for inclusion in the compositions include, but are not limited to, alkyl, hydroxyalkyl, alkylaryl, arylalkyl or arylamine quaternary salts; mono or polycyclic aromatic amine salts; imidazoline derivatives; mono-, di- or trialkyl or alkylaryl phosphate esters; phosphate esters of hydroxylamines; phosphate esters of polyols; and monomeric or oligomeric fatty acids.

Suitable alkyl, hydroxyalkyl, alkylaryl arylalkyl or arylamine quaternary salts include those alkylaryl, arylalkyl and arylamine quaternary salts of the formula [N⁺R^{5a}R^{6a}R^{7a}R^{8a}][X⁻] wherein R^{5a}, R^{6a}, R^{7a}, and R^{8a} contain one to 18 carbon atoms, and X is Cl, Br or I. For example, R^{5a}, R^{6a}, R^{7a}, and R^{8a} are each independently selected from the group consisting of alkyl (e.g., C₁-C₁₈ alkyl), hydroxyalkyl (e.g., C₁-C₁₈ hydroxyalkyl), and arylalkyl (e.g., benzyl). The mono or polycyclic aromatic amine salt with an alkyl or alkylaryl halide include salts of the formula [N⁺R^{5a}R^{6a}R^{7a}R^{8a}][X⁻] wherein R^{5a}, R^{6a}, R^{7a}, and R^{8a} contain one to 18 carbon atoms, and X is Cl, Br or I.

Suitable quaternary ammonium salts include, but are not limited to, tetramethyl ammonium chloride, tetraethyl ammonium chloride, tetrapropyl ammonium chloride, tetrabutyl ammonium chloride, tetrahexyl ammonium chloride, tetraoctyl ammonium chloride, benzyltrimethyl ammonium chloride, benzyltriethyl ammonium chloride, phenyltrimethyl ammonium chloride, phenyltriethyl ammonium chloride, cetyl benzyldimethyl ammonium chloride, hexadecyl trimethyl ammonium chloride, dimethyl alkyl benzyl quaternary ammonium compounds, monomethyl dialkyl benzyl quaternary ammonium compounds, trimethyl benzyl quaternary ammonium compounds, and trialkyl benzyl quaternary ammonium compounds, wherein the alkyl group can contain between about 6 and about 24 carbon atoms, about 10 and about 18 carbon atoms, or about 12 to about 16 carbon atoms. Suitable quaternary ammonium compounds (quats) include, but are not limited to, trialkyl, dialkyl, dialkoxy alkyl, monoalkoxy, benzyl, and imidazolinium quaternary ammonium compounds, salts thereof, the like, and combinations thereof. The quaternary ammonium salt can be an alkylamine benzyl quaternary ammonium salt, a benzyl triethanolamine quaternary ammonium salt, a benzyl alkyl(C₁₂-C₁₈) dimethylammonium salt, or a benzyl dimethylaminoethanolamine quaternary ammonium salt.

The corrosion inhibitor can be a quaternary ammonium or alkyl pyridinium quaternary salt such as those represented by the general formula:

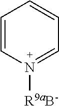

wherein R^{9a} is an alkyl group, an aryl group, or an arylalkyl group, wherein said alkyl groups have from 1 to about 18 carbon atoms and B is Cl, Br or I. Among these compounds are alkyl pyridinium salts and alkyl pyridinium benzyl quats. Exemplary compounds include methyl pyridinium chloride, ethyl pyridinium chloride, propyl pyridinium chloride, butyl pyridinium chloride, octyl pyridinium chloride, decyl pyridinium chloride, lauryl pyridinium chloride, cetyl pyridinium chloride, benzyl pyridinium and an alkyl benzyl pyridinium chloride, preferably wherein the alkyl is a C₁-C₆ hydrocarbyl group. The corrosion inhibitor can include benzyl pyridinium chloride.

The corrosion inhibitor can be an imidazoline derived from a diamine, such as ethylene diamine (EDA), diethylene triamine (DETA), triethylene tetraamine (TETA) etc. and a long chain fatty acid such as tall oil fatty acid (TOFA). Suitable imidazolines include those of formula:

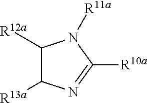

wherein R^{12a} and R^{13a} are independently a C₁-C₆ alkyl group or hydrogen, R^{11a} is hydrogen, C₁-C₆ alkyl, C₁-C₆ hydroxyalkyl, or C₁-C₆ arylalkyl, and R^{10a} is a C₁-C₂₀ alkyl or a C₁-C₂₀ alkoxyalkyl group. For example, R^{11a}, R^{12a} and R^{13a} are each hydrogen and R^{10a} is the alkyl mixture typical in tall oil fatty acid (TOFA).

The corrosion inhibitor compound can be an imidazolinium compound of the following formula:

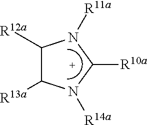

wherein R^{12a} and R^{13a} are independently a C₁-C₆ alkyl group or hydrogen, R^{11a} and R^{14a} are independently hydrogen, C₁-C₆ alkyl, C₁-C₆ hydroxyalkyl, or C₁-C₆ arylalkyl, and R¹⁰ is a C₁-C₂₀ alkyl or a C₁-C₂₀ alkoxyalkyl group.

Suitable mono-, di-and trialkyl as well as alkylaryl phosphate esters and phosphate esters of mono, di, and triethanolamine typically contain between from 1 to about 18 carbon atoms. Preferred mono-, di-and trialkyl phosphate esters, alkylaryl or arylalkyl phosphate esters are those prepared by reacting a C₃-C₁₈ aliphatic alcohol with phosphorous pentoxide. The phosphate intermediate interchanges its ester groups with triethyl phosphate with triethylphosphate producing a more broad distribution of alkyl phosphate esters.

Alternatively, the phosphate ester can be made by admixing with an alkyl diester, a mixture of low molecular weight alkyl alcohols or diols. The low molecular weight alkyl alcohols or diols preferably include C₆ to C₁₀ alcohols or diols. Further, phosphate esters of polyols and their salts containing one or more 2-hydroxyethyl groups, and hydroxylamine phosphate esters obtained by reacting polyphosphoric acid or phosphorus pentoxide with hydroxylamines such as diethanolamine or triethanolamine are preferred.

The corrosion inhibitor compound can further be a monomeric or oligomeric fatty acid. Preferred are C₁₄-C₂₂ saturated and unsaturated fatty acids as well as dimer, trimer and oligomer products obtained by polymerizing one or more of such fatty acids.

Suitable asphaltene inhibitors include, but are not limited to, aliphatic sulphonic acids; alkyl aryl sulphonic acids; aryl sulfonates; lignosulfonates; alkylphenol/aldehyde resins and similar sulfonated resins; polyolefin esters; polyolefin imides; polyolefin esters with alkyl, alkylenephenyl or alkylenepyridyl functional groups; polyolefin amides; polyolefin amides with alkyl, alkylenephenyl or alkylenepyridyl functional groups; polyolefin imides with alkyl, alkylenephenyl or alkylenepyridyl functional groups; alkenyl/vinyl pyrrolidone copolymers; graft polymers of polyolefins with maleic anhydride or vinyl imidazole; hyperbranched polyester amides; polyalkoxylated asphaltenes, amphoteric fatty acids, salts of alkyl succinates, sorbitan monooleate, and polyisobutylene succinic anhydride.

Paraffin inhibitors include, but are not limited to, paraffin crystal modifiers, and dispersant/crystal modifier combinations. Suitable paraffin crystal modifiers include, but are not limited to, alkyl acrylate copolymers, alkyl acrylate vinylpyridine copolymers, ethylene vinyl acetate copolymers, maleic anhydride ester copolymers, branched polyethylenes, naphthalene, anthracene, microcrystalline wax and/or asphaltenes. Suitable dispersants include, but are not limited to, dodecyl benzene sulfonate, oxyalkylated alkylphenols, and oxyalkylated alkylpnenolic resins.

Suitable scale inhibitors include, but are not limited to, phosphates, phosphate esters, phosphoric acids, phosphonates, phosphonic acids, polyacrylamides, salts of acrylamido-methyl propane sulfonate/acrylic acid copolymer (AMPS/AA), phosphinated maleic copolymer (PHOS/MA), and salts of a polymaleic acid/acrylic acid/acrylamido-methyl propane sulfonate terpolymer (PMA/AMPS).

Suitable emulsifiers include, but are not limited to, salts of carboxylic acids, products of acylation reactions between carboxylic acids or carboxylic anhydrides and amines, and alkyl, acyl and amide derivatives of saccharides (alkyl-saccharide emulsifiers).

Suitable dispersants include, but are not limited to, aliphatic phosphonic acids with 2-50 carbons, such as hydroxyethyl diphosphonic acid, and aminoalkyl phosphonic acids, e.g. polyaminomethylene phosphonates with 2-10 nitrogen atoms e.g. each bearing at least one methylene phosphonic acid group; examples of the latter are ethylenediamine tetra(methylene phosphonate), diethylenetriamine penta(methylene phosphonate) and the triamine- and tetramine-polymethylene phosphonates with 2-4 methylene groups between each nitrogen atom, at least 2 of the numbers of methylene groups in each phosphonate being different. Other suitable dispersion agents include lignin or derivatives of lignin such as lignosulfonate and naphthalene sulfonic acid and derivatives.

Suitable emulsion breakers include, but are not limited to, dodecylbenzylsulfonic acid (DDBSA), the sodium salt of xylenesulfonic acid (NAXSA), epoxylated and propoxylated compounds, anionic cationic and nonionic surfactants, and resins, such as phenolic and epoxide resins.

Suitable hydrogen sulfide scavengers include, but are not limited to, oxidants (e.g., inorganic peroxides such as sodium peroxide, or chlorine dioxide), aldehydes (e.g., of 1-10 carbons such as formaldehyde or glutaraldehyde or (meth)acrolein), triazines (e.g., monoethanol amine triazine, monomethylamine triazine, and triazines from multiple amines or mixtures thereof), and glyoxal.

Suitable gas hydrate inhibitors include, but are not limited to, thermodynamic hydrate inhibitors (THI), kinetic hydrate inhibitors (KHI), and anti-agglomerates (AA).

Suitable thermodynamic hydrate inhibitors include, but are not limited to, NaCl salt, KCl salt, CaCl₂ salt, MgCl₂ salt, NaBr₂ salt, formate brines (e.g. potassium formate), polyols (such as glucose, sucrose, fructose, maltose, lactose, gluconate, monoethylene glycol, diethylene glycol, triethylene glycol, mono-propylene glycol, dipropylene glycol, tripropylene glycols, tetrapropylene glycol, monobutylene glycol, dibutylene glycol, tributylene glycol, glycerol, diglycerol, triglycerol, and sugar alcohols (e.g. sorbitol, mannitol)), methanol, propanol, ethanol, glycol ethers (such as diethyleneglycol monomethylether, ethyleneglycol monobutylether), and alkyl or cyclic esters of alcohols (such as ethyl lactate, butyl lactate, methylethyl benzoate).

Suitable kinetic hydrate inhibitors and anti-agglomerates include, but are not limited to, polymers and copolymers, polysaccharides (such as hydroxy-ethylcellulose (HEC), carboxymethylcellulose (CMC), starch, starch derivatives, and xanthan), lactams (such as polyvinylcaprolactam, polyvinyl lactam), pyrrolidones (such as polyvinyl pyrrolidone of various molecular weights), surfactants (such as fatty acid salts, ethoxylated alcohols, propoxylated alcohols, sorbitan esters, ethoxylated sorbitan esters, polyglycerol esters of fatty acids, alkyl glucosides, alkyl polyglucosides, alkyl sulfates, alkyl sulfonates, alkyl ester sulfonates, alkyl aromatic sulfonates, alkyl betaine, alkyl amido betaines), hydrocarbon based dispersants (such as lignosulfonates, iminodisuccinates, polyaspartates), amino acids, and proteins.

Suitable biocides include, but are not limited to, oxidizing and non-oxidizing biocides.

Suitable non-oxidizing biocides include, for example, aldehydes (e.g., formaldehyde, glutaraldehyde, and acrolein), amine-type compounds (e.g., quaternary amine compounds and cocodiamine), halogenated compounds (e.g., bronopol and 2-2-dibromo-3-nitrilopropionamide (DBNPA)), sulfur compounds (e.g., isothiazolone, carbamates, and metronidazole), and quaternary phosphonium salts (e.g., tetrakis(hydroxymethyl)phosphonium sulfate (THPS)).

Suitable oxidizing biocides include, for example, sodium hypochlorite, trichloroisocyanuric acids, dichloroisocyanuric acid, calcium hypochlorite, lithium hypochlorite, chlorinated hydantoins, stabilized sodium hypobromite, activated sodium bromide, brominated hydantoins, chlorine dioxide, ozone, and peroxides.

Suitable pH modifiers include, but are not limited to, alkali hydroxides, alkali carbonates, alkali bicarbonates, alkaline earth metal hydroxides, alkaline earth metal carbonates, alkaline earth metal bicarbonates and mixtures or combinations thereof. Exemplary pH modifiers include NaOH, KOH, Ca(OH)₂, CaO, Na₂CO₃, KHCO₃, K₂CO₃, NaHCO₃, MgO, and Mg(OH)₂.

Suitable surfactants include, but are not limited to, anionic surfactants, cationic surfactants, zwitterionic surfactants, and nonionic surfactants.

Additional anionic surfactants include alkyl carboxylates and alkyl ether carboxylates, alkyl and ethoxylated alkyl phosphate esters, and mono and dialkyl sulfosuccinates and sulfosuccinamates.

Cationic surfactants include alkyl trimethyl quaternary ammonium salts, alkyl dimethyl benzyl quaternary ammonium salts, dialkyl dimethyl quaternary ammonium salts, and imidazolinium salts.

Nonionic surfactants include alcohol alkoxylates, alkylphenol alkoxylates, block copolymers of ethylene, propylene and butylene oxides, alkyl dimethyl amine oxides, alkyl-bis(2-hydroxyethyl) amine oxides, alkyl amidopropyl dimethyl amine oxides, alkylamidopropyl-bis(2-hydroxyethyl) amine oxides, alkyl polyglucosides, polyalkoxylated glycerides, sorbitan esters and polyalkoxylated sorbitan esters, alkoyl polyethylene glycol esters and diesters, betaines, and sultanes. Amphoteric surfactants such as alkyl amphoacetates and amphodiacetates, alkyl amphopropionates and amphodipropionates, and alkyliminodipropionate can also be used.

The surfactant can be a quaternary ammonium compound, an amine oxide, an ionic or non-ionic surfactant, or any combination thereof.

Suitable quaternary amine compounds include, but are not limited to, alkyl benzyl ammonium chloride, benzyl cocoalkyl(C₁₂-C₁₈)dimethylammonium chloride, dicocoalkyl (C₁₂-C₁₈)dimethylammonium chloride, ditallow dimethylammonium chloride, di(hydrogenated tallow alkyl)dimethyl quaternary ammonium methyl chloride, methyl bis(2-hydroxyethyl cocoalkyl(C₁₂-C₁₈) quaternary ammonium chloride, dimethyl(2-ethyl) tallow ammonium methyl sulfate, n-dodecylbenzyldimethylammonium chloride, n-octadecylbenzyldimethyl ammonium chloride, n-dodecyltrimethylammonium sulfate, soya alkyltrimethylammonium chloride, and hydrogenated tallow alkyl (2-ethylhyexyl) dimethyl quaternary ammonium methyl sulfate.

Having described the invention in detail, it will be apparent that modifications and variations are possible without departing from the scope of the invention defined in the appended claims.

### EXAMPLES

The following non-limiting examples are provided to further illustrate the present invention.

Polyacrylic acid (PAA) (3,000,000 Da and 4,000,000 Da) were purchased from Sigma Aldrich (St. Louis, Mo.) and used without further purification.

### Example 1

### Flocculation of A09B6

A polyacrylic acid (4,000,000 Da) solution was prepared at a concentration of 5 mg/mL in water. A hydrate inhibitor solution was prepared by co-polymerizing methacylamidopropyl-trimethylammonium chloride (MAPTAC) with N-isopropyl methacrylamide (IPMA).

Aliquots (1 mL) of the prepared polyacrylic acid solution were added to the hydrate inhibitor solution and vortexed. A total of 5 mL of the polyacrylic acid solution was added to the hydrate inhibitor solution. A second hydrate inhibitor solution was not treated and used as a control.

The hydrate inhibitor solution that was treated with the polyacrylic acid solution produced excellent flocculation, e.g., solids were observed floating on the surface and the liquid was clearer than prior to treatment.

### Example 2

### Flocculation of a KHI

Polyacrylic acid solutions were prepared in various concentrations as described in Table 1.

TABLE 1
Description of Polyacrylic Acid Treatment Solutions

| PAA | | Concentration |
|---|---|---|
| (MDa) | Solvent | (mg/mL) |
| 4 | H₂O | 1 |
| 4 | H₂O | 5 |
| 4 | H₂O | 10 |
| 3 | H₂O | 1 |
| 3 | H₂O | 5 |
| 3 | H₂O | 10 |
| 4 | MeOH | 5 |
| 4 | H₂O | 5* |

*Contained 50% (molar) KOH (80 mg) to produce the K⁺ salt.

A hydrate inhibitor solution was prepared by combining a low TDS, low pH brine (200 mL), a KHI comprising isopropyl methacrylate/methacrylamidopropyltrimethylammonium chloride (3.5 mL or 1.75% of the total fluids), and an amine based film forming corrosion inhibitor (0.25 mL or 0.125% of the total fluids).

Aliquots (1 mL) of the treated water solution were added to each of the polyacrylic acid solutions as listed in Table 1. A total of 2 mL of the polyacrylic acid solution was added to each hydrate inhibitor solution. Samples were mixed and gravity filtered through a WHATMAN #1 filter paper to collect any solids.

All samples treated with the polyacrylic acid solution resulted in the formation of solids. The amount of solids produced was proportional to the concentration of polyacrylic acid added to the sample. Samples treated with 10 mg/mL of the polyacrylic acid (3 MDa) in water and 5 mg/mL of the polyacrylic acid (4 MDa) in methanol produced the filtrate.

Solids filtered from samples treated with 10 mg/mL polyacrylic acid resulted in sandy, fine particulates; whereas solids filtered from samples treated with 5 mg/mL polyacrylic acid resulted in courser, granule type particles.

### Example 3

### Removal of Kinetic Hydrate Inhibitors

Polyacrylic acid solutions were prepared as described in Table 2.

TABLE 2
Description of Polyacrylic Acid Treatment Solutions

| Treatment | PAA | | Concentration |
|---|---|---|---|
| # | (MDa) | Solvent | (mg/mL) |
| 1 | 4 | MeOH | 10 |
| 2 | 3 | H₂O | 10 |

A hydrate inhibitor water solution was prepared by combining a low TDS, low pH brine (500 mL), a KHI (8.75 mL or 1.75% of the total fluids), and an amine based film forming corrosion inhibitor (0.625 mL or 0.125% of the total fluids).

Tests were conducted by adding various aliquots of the polyacrylic acid solutions, described in Table 2, to the hydrate inhibitor water solutions, as described in Table 3.

TABLE 3
Treatment Regime

| | | Quantity | |
|---|---|---|---|
| | Treatment | Added | PAA:HI |
| Trial | # | (mL) | Ratio |
| 1 | Blank | 0 | N/A |
| 2 | 1 | 8 | 1:5 |
| 3 | 1 | 13.33 | 1:3 |
| 4 | 2 | 8 | 1:5 |
| 5 | 2 | 13.33 | 1:3 |

The treated hydrate inhibitor solutions were gravity filtered through a pre-weighted WHATMAN #1 filter. The filter paper and solids were dried overnight and weighted again to determine the amount of solids collected. The results are provided in Table 4.

TABLE 4
Amount of Solids Collected Following Treatment

| | Solids | | |
|---|---|---|---|
| | Collected | % Solids | |
| Trial | (g) | removed | Normalized |
| 1 | 0.0611 | 58.2 | 52.0 |
| 2 | 0.2033 | 101.7 | 90.8 |
| 3 | 0.2390 | 94.3 | 84.3 |
| 4 | 0.2121 | 106.1 | 94.7 |
| 5 | 0.2836 | 111.9 | 100.0 |

### Example 4

### Flocculation to Determine % Non-Volatile Residue

A polyacrylic acid (3,000,000 Da) solution was prepared at a concentration of 10 mg/mL in water. Four hydrate inhibitor solutions were prepared, each comprising a low TDS, low pH brine (40 mL), a KHI (700 μL or 1.75% of the total fluids), and a corrosion inhibitor (50 μL or 0.125% of the total fluids).

The polyacrylic acid solution was used to treat the hydrate inhibitor solution as described in Table 5, below.

TABLE 5
Description of Polyacrylic Acid Treatment Solutions

| | Inhibitor Soln. | PAA Soln. | PAA:LDHI |
|---|---|---|---|
| Trial | (mL) | (mL) | Ratio |
| 1 | 40 | 8 | 2.5:1 |
| 2 | 40 | 13.3 | 1.5:1 |
| 3 | 40 | 20 | 1:1 |
| 4* | 40 | 80 | |

*80 mg of 3,000,000 Da PPA solids were added.

The treated hydrate inhibitor solutions were shaken and gravity filtered to remove any solids. The resulting solutions were colorless and free of any haze and solids, even at an elevated temperature (50° C.). The filtrate was analyzed by thermogravimetric analysis for solid content (% non-volatile residue, NVR) and the results are provided in Table 6, below.

TABLE 6
% Non-Volatile Residue Test Results

| Trial | % NVR |
|---|---|
| 1 | 0.1628 |
| 2 | 0.1664 |
| 3 | 0.2741 |
| 4 | 0.1394 |

### Example 5

### Flocculation Using Neutral Hydrate Inhibitors

A polyacrylic acid (3,000,000 Da) solution was prepared at a concentration of 10 mg/mL water. The following kinetic hydrate inhibitors were prepared as test solutions: poly(vinyl caprolactam)-co-poly(vinyl pyrrolidone)-co-poly(dimethylaminoethyl methacrylate) copolymer (commercially available from Ashland Inc. as Product GAFFIX VC-713 and identified hereinafter as composition A), poly(N-vinylpyrrolidone) (commercially available from Ashland Inc. as Product PVP K-30 and identified hereinafter as composition B), Nalco Champion Product EC6481A (identified hereinafter as composition C), poly(vinyl caprolactam)-co-poly(N-vinyl pyrrolidone) (commercially available from Ashland Inc. as Product INHIBIX 501 and identified hereinafter as composition D), and INHIBEX 550 (commercially available from Ashland Inc. and identified hereinafter as composition E). The aforementioned kinetic hydrate inhibitors were prepared, either from a solid form, a concentrated liquid, or used as supplied, as described in Table 7.

TABLE 7
Description of Kinetic Hydrate Inhibitor Solutions

| | Hydrate | | Concentration |
|---|---|---|---|
| Formulation | Inhibitor | Type | (%) |
| 1 | ^{a}A | Neutral | 23.1 |
| 2 | B | Neutral | 18.1 |
| 3 | ^{a}C | Neutral | 20.39 |
| 4 | ^{a}D | Neutral | 20.44 |
| 5 | ^{a}E | Anionic | 20 |

^{a}Diluted from concentrate.

The polyacrylic acid solution (10 mL), a kinetic hydrate inhibitor (8 mL), and a low TDS, low pH (40 mL) solution were combined. The resulting solution was stirred and allowed to settle. It should be noted that the hydrate inhibitor solutions were clear prior to the addition of the polyacrylic acid solution.

Following the addition of the polyacrylic acid solution, all hydrate inhibitor solutions precipitated to some degree. After the addition of the polyacrylic acid solution to hydrate inhibitor C, a precipitate formed which resulted in a clear liquid layer.

Upon mixing the polyacrylic acid solution with hydrate inhibitor E, the solution clouded up and a white precipitate was filtered off which resulted in a clear solution.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above products and methods without departing from the scope of the invention, it is intended that all matter contained in the above description shall be interpreted as illustrative and not in a limiting sense.

1. A method for removing a polymeric low dose hydrate inhibitor from an aqueous fluid containing the polymeric low dose hydrate inhibitor, the method comprising contacting the aqueous fluid containing the polymeric low dose hydrate inhibitor with a high molecular weight polymeric flocculant.

2. The method of claim 1, wherein the aqueous fluid comprises a waste stream.

3. The method of claim 2, wherein the waste stream comprises an aqueous liquid, an organic liquid, or a combination thereof.

4. The method of claim 1, wherein the polymeric low dose hydrate inhibitor comprises a polymeric kinetic hydrate inhibitor.

5. The method of claim 1, wherein the high molecular weight polymeric flocculant comprises repeat units derived from an anionic monomer.

6. The method of claim 5, wherein the anionic monomer comprises an acrylic acid, a methacrylic acid, a vinyl sulfonate, a vinyl sulfonic acid, a styrene sulfonate, a styrene sulfonic acid, a vinyl alcohol, a vinyl phosphonate, a vinyl phosphonic acid, or a combination thereof.

7. The method of claim 6, wherein the anionic monomer comprises acrylic acid.

8. The method of claim 6, wherein the molecular weight of the high molecular weight polymeric flocculant is from about 100,000 Da to about 100,000,000 Da, using viscosity molecular weight (Mv).

9. The method of claim 8, wherein the molecular weight of the polymer is from about 1,000,000 Da to about 100,000,000 Da.

10. The method of claim 1, wherein the high molecular weight polymeric flocculant is formulated with a polar solvent.

11. The method of claim 10, wherein the polar solvent comprises water, brine, methanol, ethanol isopropyl alcohol, a C₁-C₁₀ alcohol, a C₁-C₁₀ diol, a C₁-C₁₀ carboxylic acid, a C₁-C₁₀ dicarboxylic acid, monoethylene glycol (MEG), diethylene glycol ethyl ether (EDGE), ethylene glycol monobutyl ether (EGMBE) or related glycol ethers or a combination thereof.

12. The method of claim 11, wherein the polar solvent comprises water.

13. The method of claim 1, wherein the high molecular weight polymeric flocculant is formulated with a polar solvent at a concentration of from about 0.001 to about 10 wt. % based on the total weight of the composition.

14. The method of claim 1, wherein the high molecular weight polymeric flocculant is contacted with the aqueous fluid in the form of a solid or as a solution.

15. The method of claim 14, wherein the high molecular weight polymeric flocculant is contacted with the aqueous fluid as a solution.

16. The method of claim 1, wherein the high molecular weight polymeric flocculant is contacted with the aqueous fluid at a concentration from about 0.001 wt. % to about 10 wt. % based on the amount of the hydrate inhibitor in the solution.

17. The method of claim 16, wherein the high molecular weight polymeric flocculant is contacted with the aqueous fluid at a concentration from about 0.1 wt. % to about 2 wt. %.

18. The method of claim 9, wherein the high molecular weight polymeric flocculant is contacted with the aqueous fluid at a concentration from about 0.001 wt. % to about 10 wt. % based on the amount of the hydrate inhibitor in the solution.

19. The method of claim 7, wherein the molecular weight of the polymer is from about 1,000,000 Da to about 100,000,000 Da and the high molecular weight polymeric flocculant is contacted with the aqueous fluid at a concentration from about 0.1 wt. % to about 2 wt. %.
